(19) United States
(12) Patent Application Publication
(10) Pub. No.: US 2014/0324621 A1
(43) Pub. Date: Oct. 30, 2014

(54) CONSOLIDATION MANAGER FOR THIRD PARTY SERVICES

(71) Applicant: Clarke Harrison, LLC, Provo, UT (US)

(72) Inventors: James Harrison, Miami Beach, FL (US); Danny Ramdenee, Essex (GB)

(73) Assignee: Clarke Harrison, LLC, Provo, UT (US)

(21) Appl. No.: 14/263,840

(22) Filed: Apr. 28, 2014

Related U.S. Application Data
(60) Provisional application No. 61/816,833, filed on Apr. 29, 2013.
(60) Provisional application No. 61/865,535, filed on Aug. 13, 2013.

(51) Int. Cl. G06Q 30/04; G06Q 30/06

(52) U.S. Cl. CPC G06Q 30/04; G06Q 30/0611
USPC 705/26.4; 705/34

(57) ABSTRACT

A system consolidates user interactions with providers of goods and/or services. The system includes an electronic data storage device to store user information corresponding to a user. The system also includes a data processor to administer electronic communications with a plurality of the providers of goods and/or services. The system also includes a consolidation manager to aggregate information from the plurality of the providers into a consolidated format for presentation to the user. Embodiments of the system may aggregate quote information, billing information, and other similar types of information.

### CROSS-REFERENCE TO RELATED APPLICATIONS

This application claims the benefit of U.S. Provisional Application No. 61/816,833 (Docket No. 0001.CLHA.PR), filed on Apr. 29, 2013, which is incorporated by reference herein in its entirety. This application also claims the benefit of U.S. Provisional Application No. 61/865,535 (Docket No. 0018.CLHA.PR), filed on Aug. 13, 2013, which is incorporated by reference herein in its entirety.

### BACKGROUND

Consumers have substantial information and powerful tools available to make purchasing and payment decisions. The amount of information available on the internet facilitates seemingly endless research into potential purchases, specific products, and different retailers and service providers (referred to jointly or separately as providers). Similarly, there are many tools available to interface with each provider. For example, each provider may have their own website with general information, as well as proprietary portals to allow users to maintain private accounts for making purchases, storing personal and financial information, and making payments to the provider.

While the ability to interface individually with each provider offers flexibility, there are often times when consumers are required to perform redundant actions in order to interface with multiple providers. Some areas where consumers often find redundant actions include comparison shopping and bill payments. These redundant actions are inefficient for the consumer to the extent that the consumer must enter in duplicate information into different websites or perform duplicate actions for different providers.

As one example, electronic commerce has made it easier for a consumer to obtain information and make purchases of a service and/or a product online. However, if the consumer desires to compare the services and/or products offered by different providers, the consumer (i.e., a potential customer) often must interface with each individual provider's website separately in order to determine which provider's service and/or product is the one best suited for the consumer. At each interface, the consumer typically is requested to enter information, data, preferences, etc. which can be tedious and time consuming. Entering the same or similar information into different websites is inefficient for the consumer. Additionally, the consumer is often required to engage in follow-up communications with multiple, individual providers to identify which service and/or product being offered is best suited for his or her needs, as well as to obtain the best value for such service and/or product. Thus, the overall process may be inconvenient.

As another example, consumers receive a large number of bills relating to services and/or goods received or purchased during a particular billing cycle. Such bills are typically transmitted electronically or otherwise mailed in hard-copy form to the consumer. The consumer then reviews the bills and sends a check or other suitable payment to the originator of the bill. This process is often repeated each month, or on some recurrent basis, for each provider. In other words, the conventional methods for the receipt, payment, and processing of bills is a time consuming a laborious process. Processing individual bills using otherwise redundant processes for different providers is inefficient for the consumer.

In each of these examples, consumers receive information from multiple providers and try to process that information. Whether processing that information individually, or trying to draw comparisons between different providers, consumers are faced with inefficient processes that require redundant tasks from the consumer.

Additionally, the general consuming public may distrust providers because the identifying information provided to a provider on its website may be subsequently used to subject a consumer to various undesirable marketing methods or other communications (e.g., mass telephone calling campaigns and/or electronic mass mailings). Calls and/or emails received as a result of the consumer providing such information to the provider are usually unsolicited and regarded as a nuisance.

### SUMMARY

Embodiments of a system are described. In one embodiment, the system consolidates user interactions with providers of goods and/or services. An embodiment of the system includes an electronic data storage device, a data processor, and a consolidation manager. The electronic data storage device stores user information corresponding to a user. The data processor administers electronic communications with a plurality of the providers of goods and/or services. The consolidation manager aggregates information from the plurality of the providers into a consolidated format for presentation to the user. Further embodiments of the system may aggregate quote information, billing information, and other similar types of information. Other embodiments of the system are also described.

Embodiments of a method are also described. In one embodiment, the method is a method for consolidating payment information. An embodiment of the method receiving billing information of a user for a plurality of existing accounts with a corresponding plurality of providers of goods and/or services. The method also includes aggregating the billing information from the plurality of the existing accounts. The method also includes generating a consolidated bill for the user based on the aggregated billing information. The method also includes delivering the consolidated bill to the user. Other embodiments of the method for consolidating payment information are also described.

In another embodiment, the method is a method for anonymous comparison shopping. An embodiment of the method includes receiving identifying information from a user. The method also includes assigning new identifying information to the user. The method also includes sending at least a portion of the new identifying information to a vendor to request a quote. The method also includes delivering the quote from the vendor to the user. Other embodiments of the method for anonymous comparison shopping are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a consumer transaction system.

FIG. 2 depicts a schematic block diagram of one embodiment of the consolidation manager of FIG. 1.

FIG. 3 depicts a schematic block diagram of one embodiment of the payment consolidator of FIG. 2.

FIG. 4 depicts a schematic block diagram of one embodiment of the data passport of FIG. 3.

FIG. 5 depicts a schematic block diagram of one embodiment of the comparison engine of FIG. 3.

FIG. 6 depicts a schematic block diagram of one embodiment of the billing engine of FIG. 3.

FIG. 7 depicts a schematic block diagram of one embodiment of the services engine of FIG. 3.

FIG. 8 depicts a schematic block diagram of one embodiment of an API architecture to implement the functionality of the payment consolidator of FIG. 2.

FIG. 9 depicts a flow chart diagram of one embodiment of a payment consolidation method for implementation with the payment consolidator of FIG. 2.

FIG. 10 depicts a schematic block diagram of one embodiment of the quote consolidator of FIG. 2.

FIG. 11 depicts a schematic block diagram of another embodiment of a quote consolidator.

FIG. 12 depicts a schematic block diagram of another embodiment of a quote consolidator.

FIG. 13 depicts a schematic block diagram of another embodiment of a quote consolidator.

FIG. 14 depicts a schematic block diagram of another embodiment of a quote consolidator.

FIG. 15 depicts a schematic block diagram of another embodiment of a quote consolidator.

FIG. 16 depicts a flow chart diagram of one embodiment of a quote consolidation method for implementation with the quote consolidator of FIG. 2.

FIG. 17 depicts a flow chart diagram of another embodiment of a quote consolidation method for implementation with the quote consolidator of FIG. 2.

FIG. 18 depicts a flow chart diagram of another embodiment of a quote consolidation method for implementation with the quote consolidator of FIG. 2.

Throughout the description, similar reference numbers may be used to identify similar elements.

### DETAILED DESCRIPTION

The invention and accompanying drawings will now be discussed in reference to the numerals provided therein so as to enable one skilled in the art to practice the present invention. The skilled artisan will understand, however, that the inventions described below can be practiced without employing these specific details, or that they can be used for purposes other than those described herein. Indeed, they can be modified and can be used in conjunction with products and techniques known to those of skill in the art in light of the present disclosure. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

It will be appreciated that in some configurations, some or all of the software is stored in a non-transitory state such that the software, or representations thereof, persist in the same physical location for a period of time. Additionally, in some configurations some or all of the software is stored on one or more non-transitory storage devices, which include hardware elements capable of storing non-transitory states and/or signals representative of the software, even though other portions of the non-transitory storage devices may be capable of altering and/or transmitting the signals. Examples of a non-transitory storage devices includes, but are not limited to read-only memory (ROM), random access memory (RAM), flash memory, magnetic disks, optical disks, integrated circuits, flip-flops and other logical state devices, and so forth. Each of these non-transitory storage devices can store signals and/or states representative of the software portions for a period of time. However, the ability to store the signals and/or states is not diminished by further functionality of transmitting signals that are the same as or representative of the stored signals and/or states. For example, a processor may access the non-transitory storage device to obtain signals that are representative of the stored signals and/or states in order to execute the corresponding software instructions.

Furthermore, the present invention may take the form of a computer program product on a computer-usable storage medium having computer-usable program code embodied in the medium. Any suitable computer usable or computer readable medium may be utilized. The computer-usable or computer-readable medium may be, for example but not limited to, an electronic, magnetic, optical, electromagnetic, or semiconductor system, apparatus, device, etc. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute on a special purpose data processor, a general-purpose computer, a computer system, or a group of networked computers or computer systems configured to perform the steps or modes of the methods of the invention. The processor or computer used to execute the program code may be connected to one or more user computer(s), phone(s), or other mobile device(s) through, for example, the Internet using an Internet Service Provider.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

While many embodiments are described herein, at least some of the described embodiments facilitate consolidating user interactions with providers of goods and/or services. By consolidating the number of interactions that a user might make with various providers, vendors, and so forth, embodiments of the systems and methods described herein may help the user to be more efficient in researching products and services. Similarly, embodiments of the systems and methods described herein may help a user to process information and transactions more thoroughly and/or more quickly, which can be beneficial to both the user and the providers.

Some embodiments described herein relate more specifically to online comparison shopping. In particular, at least some of the embodiments facilitate third party service and/or product comparisons. These embodiments fulfill a need for improved techniques for providing third party service and/or product comparisons. The independent nature of a comparison system should engender consumer trust such that the consumer is assured that his or her identifying information will not be used for subsequent, unsolicited marketing campaigns or other unwanted communications

Some embodiments described herein relate more specifically to a consumer-based bill consolidation, price comparison, and payment aggregation system. In particular, embodiments facilitate consumer-vendor interactions which may end with various results including bill consolidation, payment aggregation, and delivery of price comparison data and/or other information to a consumer. This approach alters the traditional paradigm of bill generation and payment. Such a system may offer a variety of benefits to the consumer, such as facilitating receipt and payment of bills, providing information for alternative goods and/or services, etc.

For convenience, the term “customer” or “consumer” is used throughout this document to represent a typical person or entity who consumes goods and/or services from a provider. A provider may include any person or entity that makes goods or services available for purchase (e.g., vendors) or consumption by a consumer. The terms consumer and provider (and similar terms) are not limited other than to designate recipients and providers of transactions exchanging goods and/or services.

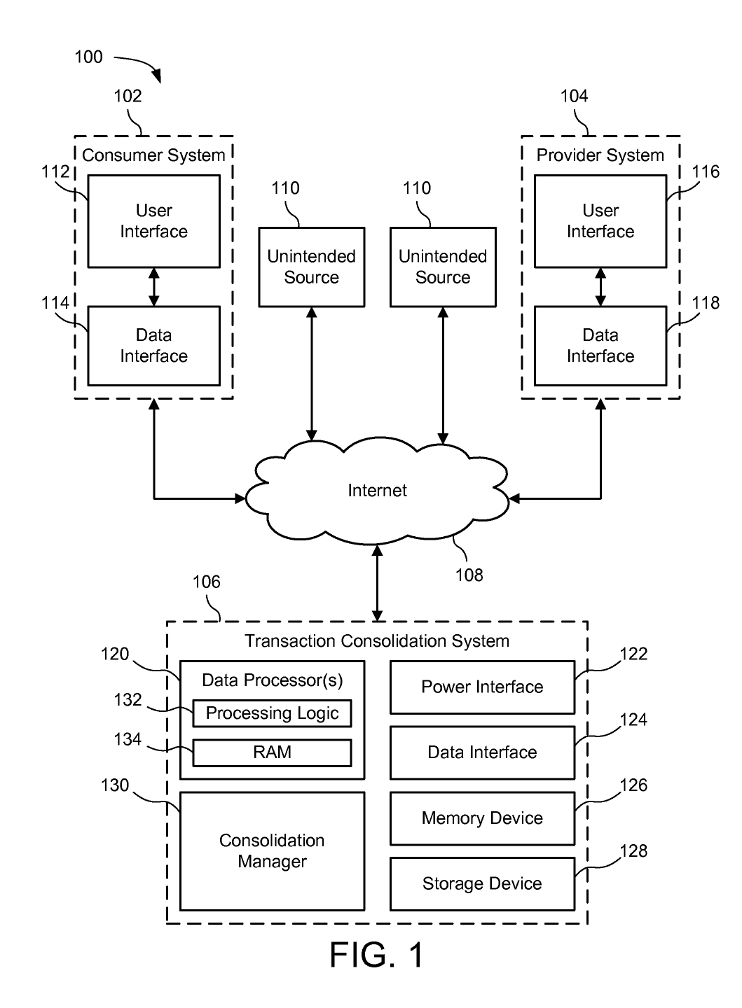

FIG. 1 depicts a schematic block diagram of one embodiment of a consumer transaction system 100. The illustrated consumer transaction system 100 includes a consumer system 102, a provider system 104, and a transaction consolidation system 106. Each of these systems 102, 104, and 106 are coupled to the internet 108. The consumer transaction system 100 also includes one or more unintended sources 110 coupled to the internet 108.

Embodiments of the consumer transaction system 100 implement functionality for consumer-based data collection, bill consolidation, price comparison, and payment aggregation, as described below. Although the illustrated consumer transaction system 100 is shown with certain components and described herein with certain functionality, other embodiments of consumer transaction systems may include a different number of components to implement the same or similar functionality. For example, other embodiments of the consumer transaction system 100 may use a different type of network implementation other than the internet 108 to facilitate communications among the various system components. Also, the consumer transaction system 100 may facilitate multiple consumer interactions between a single consumer and multiple providers. Similarly, the consumer transaction system 100 may facilitate multiple consumer transactions between multiple consumers and a single provider.

All types of utilities, such as telephone, energy, water, gas, cable, and home security, can deliver their products and services to customers efficiently and expertly. However, many utilities and other providers are not particularly efficient or expert in the corresponding administrative tasks such as billing, receivable management, collections, data warehousing, and marketing or database marketing. Embodiments of the consumer transaction system 100 described herein may streamline data collection and computerized combined billing to provide a tremendous convenience to the consumer and the provider. For example, embodiments of the system 100 may give the consumer the ability to receive multiple statements in a consolidated bill with multiple payment options or reward propositions.

At the same time, embodiments of the system 100 may provide valuable cost advantages or other efficiencies to the utilities or providers. Instead of managing multiple collection calls to a consumer, for example, to collect for these energy, telephone, and credit card bills, a single call may be sufficient required. Further, processing costs (i.e., the costs for processing the payment), statement delivery costs, collections cost, credit warehousing and data cost, and management and system infrastructure cost may be leveraged across a wide array of services. Moreover, in addition to the incremental cost advantages, embodiments described herein may allow for exclusive distribution rights for delivering products and services to the marketplace.

The illustrated consumer system 102 includes a user interface 112 and a data interface 114. The consumer system 102 may include other typical components such as processing components and so forth. The user interface 112 may be any type of device that allows a consumer or other user, or an automated service, to interface with the consumer system 102 by inputting information into and/or receiving information from the consumer system 102. The data interface 114 may be any type of component capable of transmitting data to and receiving data from other communication partners over the internet or a network. Some example implementations of the consumer systems 102 include, but are not limited to, desktop computers, laptop computers, tablets, mobile telephones, personal digital assistants, and so forth. In some embodiments, a consumer may utilize the consumer system 102 to communicate with the transaction consolidation system 106 from a website or mobile website application (“mobile app”) via the internet 108. Embodiments of the transaction consolidation system 106 are not limited by the type of consumer system 102 that may be in communication with the transaction consolidation system 106.

The illustrated provider system 104 includes a user interface 116 and a data interface 118. The provider system 104 may include other typical components such as processing components and so forth. The user interface 116 may be any type of device that allows a consumer or other user, or an automated service, to interface with the provider system 104 by inputting information into and/or receiving information from the provider system 104. The data interface 118 may be any type of component capable of transmitting data to and receiving data from other communication partners over the internet or a network. Some example implementations of the provider system 104 include, but are not limited to, desktop computers, laptop computers, tablets, mobile telephones, personal digital assistants, and so forth. In some embodiments, a user may utilize the provider system 104 to communicate with the transaction consolidation system 106 from a website or mobile website application (“mobile app”) via the internet 108. Embodiments of the transaction consolidation system 106 are not limited by the type of provider system 104 that may be in communication with the transaction consolidation system 106.

By way of example, the illustrated transaction consolidation system 106 includes a data processor 120, a power interface 122, a data interface 124, a memory device 126, and a storage device 128. The transaction consolidation system also includes a consolidation manager 130. Although the illustrated transaction consolidation system 106 is shown with certain components and described herein with certain functionality, other embodiments of transaction consolidation systems may include a different number of components to implement the same or similar functionality.

In general, the processor 120 is any type of data processing device or combination of data processing devices. The processor 120 executes instructions to cause the transaction consolidation system 106 to implement operations. The illustrated processor 120 includes processing logic 132 and random access memory (RAM) 134. In some embodiments, the processor 120 loads and executes an operating system that provides an interface for user interactions and/or system communications. The processor 120 also may load a file or other data structure management system to manage files or other data structures stored on the transaction consolidation system 106. Embodiments of the transaction consolidation system 106 are not limited in the type of processor 120 and/or processing functions that can be performed by the processor 120.

In some embodiments, the processor 120 incorporates some or all of the logic for the consolidation manager 130. The logic for the consolidation manager 130 may be incorporated into the processing logic 132 or may be loaded into the RAM 134 in order to program the processor 120 to perform special functions directed to consolidating interactions between the consumer system 102 and multiple provider systems 104.

In one embodiment, the power interface 122 acts as a connection through which power is provided from an external source (not shown) to the internal components of the transaction consolidation system 106. Embodiments of the transaction consolidation system 106 are not limited in the type of power interface 122 that may be incorporated.

In one embodiment, the data interface 124 facilitates data communications with external communication partners such as the consumer system 102 and the provider system 104. The data interface 124 may include hardware components to transmit and receive communications over wired and or wireless communications paths using any known or comparable communications protocols. In this manner, the data interface 124 may facilitate communications for incoming data, outgoing data, or both. There is no limitation on the types of communication hardware or protocols that might be implemented for the data interface 124.

In one embodiment, the memory device 126 and the storage device 128 store electronic data (or states representative of data values). The memory device 126 and the storage device 128 may implement any type of physical and/or logical data structures and addressing to facilitate storing and retrieving data values according to instructions from the data processor 120. There is no limitation on the types of devices or configurations that might be implemented for the memory device 126 and the storage device 128.

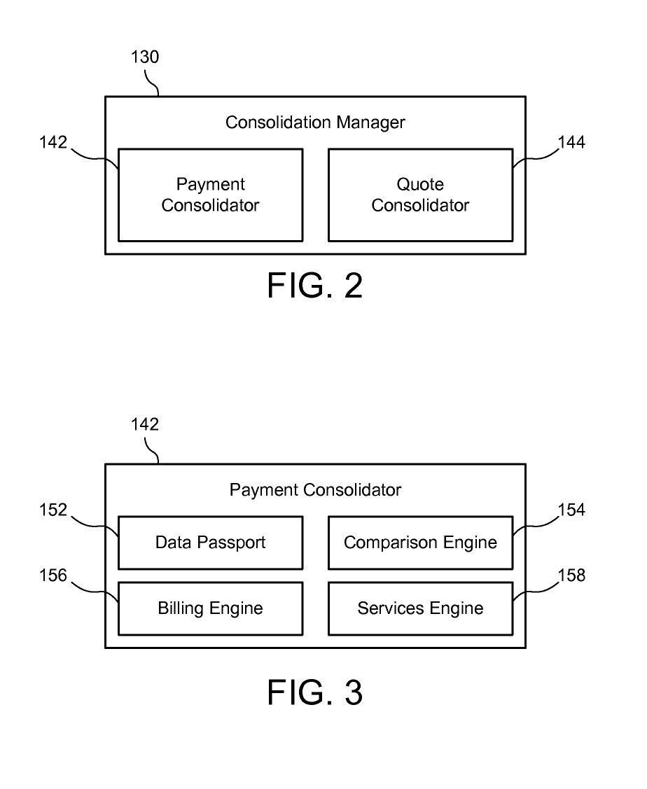

FIG. 2 depicts a schematic block diagram of one embodiment of the consolidation manager 130 of FIG. 1. In general, the consolidation manager 130 of the transaction consolidation system 106 facilitates a user of the consumer system 102 to interface with multiple provider systems 104 in a consolidated manner. In some embodiments, the information from various provider systems 104 is presented in a consolidated or aggregated way to the consumer. The consumer may be a current customer of, or have another type of current affiliation with, the providers associated with the consolidated provider systems 104. Alternatively, the consumer may be prospecting multiple providers with whom the consumer does not have an existing relationship. In another embodiment, the consumer may be evaluating services from multiple providers, regardless of whether the consumer might have an existing relationship with one or more of the evaluated providers.

Additionally, the consolidation manager 130 may facilitate a user of the provider system 104 to interface with multiple consumer systems 102 in a consolidated manner. In some embodiments, the information from various consumer systems 102 is presented in a consolidated or aggregated way to the provider.

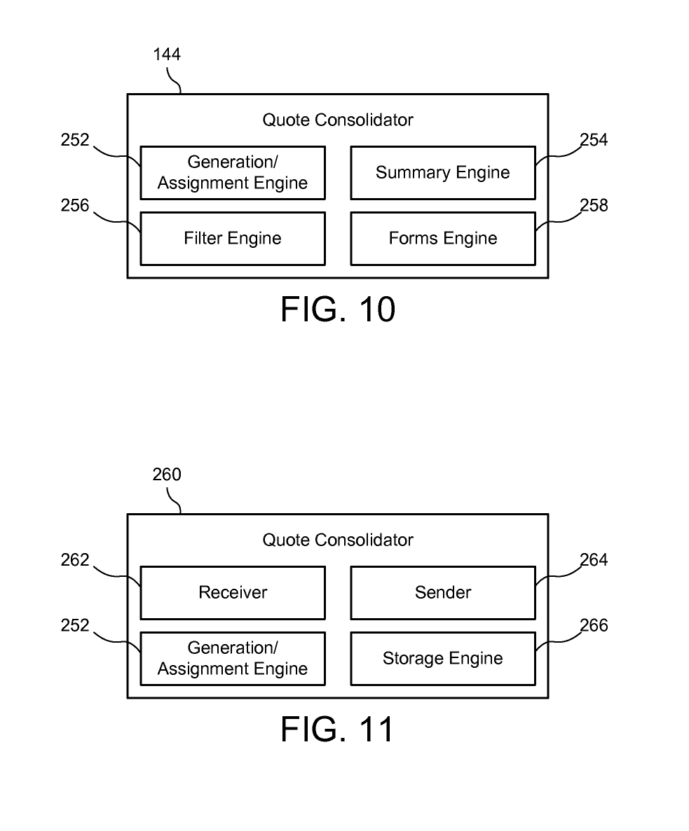

The illustrated consolidation manager 130 includes a payment consolidator 142 and a quote consolidator 144. An embodiment of the payment consolidator 142 is shown in FIG. 3 and described in more detail with reference to FIGS. 3-9. An embodiment of the quote consolidator 144 is shown in FIG. 10 and described in more detail with reference to FIGS. 10-19.

FIG. 3 depicts a schematic block diagram of one embodiment of the payment consolidator 142 of FIG. 2. In general, the payment consolidator 142 aggregates billing and payment information and actions for a consumer. This gives the consumer a single interface to receive and process billing information from multiple providers. The illustrated payment consolidator includes a data passport 152, a comparison engine 154, a billing engine 156, and a services engine 158. Other embodiments of the payment consolidator 142 may have fewer or more components.

In some embodiments, the payment consolidator 142 and its various components are implemented as software functions or modules stored on a tangible memory or storage device. In this implementation, the illustrated diagrams may be representative of computer program products in which executable software code is stored on a physical storage medium that can store signals representative of the executable software code in a non-volatile and non-transitory state, physically interface with the processor 120, and provide the stored executable software code to the processor 120 in response to instructions from the processor 120.

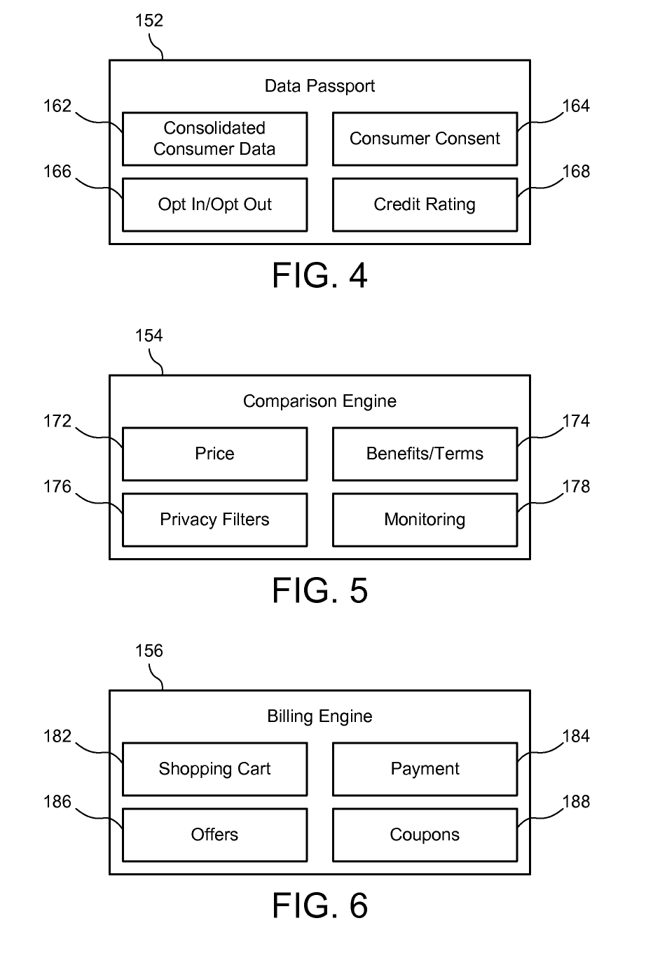

FIG. 4 depicts a schematic block diagram of one embodiment of the data passport 152 of FIG. 3. The consumer system 102 may provide identifying information to the transaction consolidation system 106. The data processor 120 may be configured to receive the identifying information and use a data passport 152 to collect and consolidate information sent by the consumer. The identifying information may be collected via third party website upon authorization/consent of the consumer, via photograph (e.g., a picture of a bill for the consumer) which is transformed into machine readable text, etc.

The data passport 152 may be used to consolidate and store substantially all data relating to a consumer (e.g., the consumer's account information). This allows the consumer to control the data, including how and when the data is disseminated to one or more providers 104. For example, the consumer may use the consumer system 102 to allow or disallow consent for use of the consumer's data with particular organizations, to make automated payments, etc. In the illustrated embodiments, the data passport 152 includes consolidated consumer data 162, consumer content data 164, opt-in and opt-out data 166, and credit rating data 168. In some embodiments, the consolidated consumer data 162 may include a single, encapsulated packet that allows the consumer to have some manner of control over the collected data, including how the data is disseminated. The consumer consent data 164 may allow the consumer to allow or disallow consent for use of data, automated payments, etc. The opt-in/opt-out data 166 allows a consumer to choose which organization(s) he or she wants to interact with or receive information from. The credit rating data 168 stores information and preference related to the use of the consumer's credit rating and authorizations for providers to access such information.

The transaction consolidation system 106 may use the information in the data passport 152 in a variety of ways. Information in the data passport 152 may be used for additional functionality, as explained in more detail below. The information may be used to interact directly with third party providers 104. The information may be used to assign a credit worthiness rating to the consumer. Other embodiments may facilitate additional uses of the data within the data passport 152.

FIG. 5 depicts a schematic block diagram of one embodiment of the comparison engine 154 of FIG. 3. The illustrated comparison engine 154 facilitates comparing the goods and/or services of two or more providers. The comparison engine 154 may include functionality to compare prices of like goods and/or services for a variety industries or industry subsets. The comparison engine 154 may communicate with the data passport 152 and the use information collected and consolidated relative to a specific consumer to make price comparisons that are relevant to the consumer. Additionally, the comparison engine 154 may allow the consumer to set parameters (such as budget), reduce price of a good/service based on a number of factors, data mine and analyze a wide range of products and services, etc. Furthermore, the comparison engine 154 may take into consideration the benefits and/or terms associated with like products and/or services. The comparison engine 154 may also include parameters that allow the comparison engine 154 to interact with providers and corresponding provider systems 104 in a manner that ensures that the identity of a particular consumer is not revealed to the provider, thus maintaining the privacy of the particular consumer.

The comparison engine 154 may include dynamic monitoring of a particular customer's contracts with various providers to ensure that information regarding the best available competing products is available to the consumer. Such monitoring may be performed on a substantially continuous basis, or may be performed at predetermined times, e.g., at or near the end of the contract term of an existing contract, or in response to a change in circumstances (qualifying/non-qualifying factors), etc. Results from the dynamic monitoring may be provided to the consumer in the form of feedback. Additionally, the comparison engine 154 may provide special offers and additional potential savings based on a consumer's opt-in/opt-out settings and consent settings included in the data passport 152.

As examples, the illustrated comparison engine 154 includes a price comparator 172 which may be used to perform price comparisons across many types of providers for a variety of goods and/or services. The illustrated comparison engine 154 also includes a benefits/terms comparator 174 which may be used to analyze contract terms and “lock-ins” to aid in the determination of the overall value of a product or service offered by a particular provider. The illustrated comparison engine 154 also includes one or more privacy filters 176 to protect information about a consumer. The illustrated comparison engine 154 also includes a monitoring engine 178 for scheduled or periodic monitoring of all of a consumer's contracts to ensure that the best deal is being presented to the consumer.

FIG. 6 depicts a schematic block diagram of one embodiment of the billing engine 156 of FIG. 3. The illustrated billing engine 156 is generally functional to consolidate one or more of a consumer's bills received from various providers. In some embodiments, the billing engine 156 also allows a consumer to make a single payment on the consolidated bill. In a more specific embodiment, the billing engine 156 may allow for a single payment using a revolving credit account, and the consumer may gain points and discounts (or receive other promotional awards) for making a payment using the revolving credit account.

In further embodiments, the billing engine 156 may include additional functionality to automatically switch a consumer from one provider to a competing provider, provide loyalty bonuses, provide multi-product bonuses/savings, or provide other special offers or coupons such as introductory offers, etc. The billing engine 156 also may allow for delivery of contract revisions and expiration notices, provide automated selection of alternatives, notify the consumer of a change in the status of a provider, provide for the ability to react to a change in price, provide calendar reminders, etc.

As examples, the billing engine 156 includes a shopping cart 182. The shopping cart 182 may be configured to present an interface to a consumer to manage multiple payments to a variety of providers, allow for delivery of contract revisions and expiration notice, provide automated selection of alternatives, notify the customer of a change in the status of a provider, provide for the ability to react to a change in price, provide calendar reminders, etc. The illustrated billing engine 156 also includes a payment engine 184 to initiate the payments to the various providers using, for example, any payment instructions that are specific to each provider. The illustrated billing engine 156 also includes offer data 186 which provides functionality to automatically switch a customer from one provider to a competing provider, provide loyalty bonuses, provide multi-product bonuses/savings, or provide other special offers such as introductory offers, etc. The illustrated billing engine 156 also includes coupon data 188 which may include functionality to provide a customer with one-off special deals and/or savings.

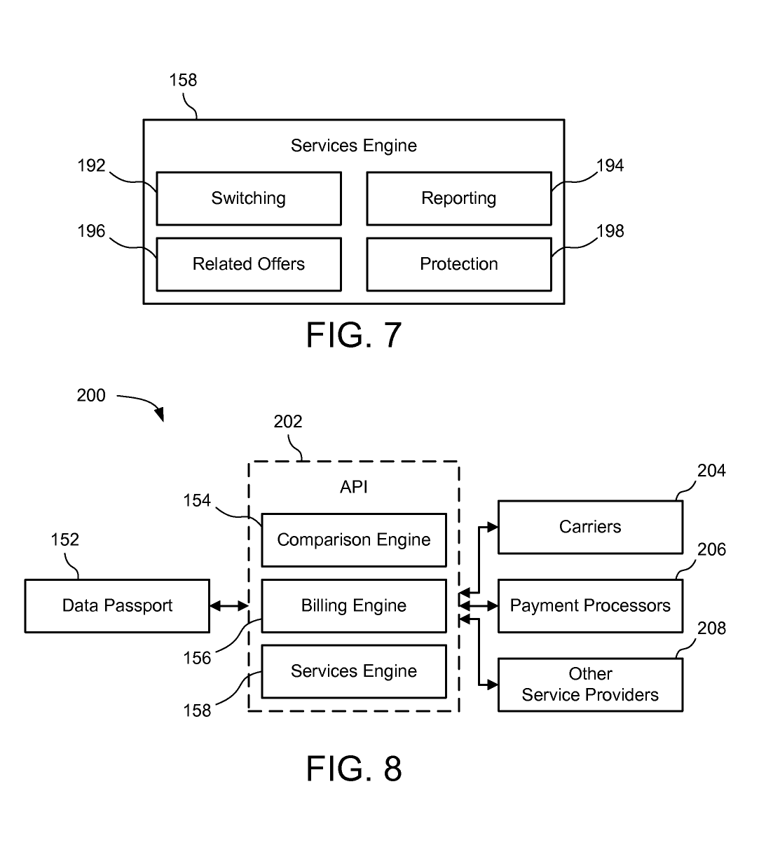

FIG. 7 depicts a schematic block diagram of one embodiment of the services engine 158 of FIG. 3. The illustrated services engine 158 provides a variety of services to a consumer. The services engine 158 may include one or more of the following: automatic contract switching based on consent and terms of contract; advisory service to present a consumer with improved savings, benefits, terms, etc.; end of contract monitoring to offer advance recommendations; and improved technology recommendations. The service engine 158 also may provide reporting in the form of consolidating product/service billing reports, provide related offers from competing third parties based on information in a data passport 152 and/or based on the consumer's consent or opt-in/opt-out preferences, and provide various protections to the consumer (e.g., security and encryption, password and financial data storage and retrieval, identity theft and fraud protection, keys, cards, etc.).

As examples, the illustrated service engine 158 includes switching data 192 that includes functionality to, for example, switch contracts automatically based on consent and terms of contract; provide advisory services to present a customer with improved savings, benefits, terms, etc.; provide end of contract monitoring to offer advance recommendations; provide improved technology recommendations, etc. The illustrated service engine 158 also includes reporting data 194 which may consolidate product/service billing reports. The illustrated service engine 158 also includes related offers data 196 that provides related offers from competing third parties based on information in the data passport 152 a consumer's consent or opt-in/opt-out preferences. The illustrated service engine 158 also includes protection data 198 to provide various protections (e.g., security and encryption, password and financial data storage and retrieval, identity theft and fraud protection, keys, cards, etc.) to a consumer.

FIG. 8 depicts a schematic block diagram of one embodiment of an API architecture 200 to implement the functionality of the payment consolidator 142 of FIG. 2. The illustrated API architecture 200 makes use of an application programming interface (API) 202 to specify potential interactions of the various engines 154, 156, and 158 with different types of providers of goods and/or services.

In the illustrated embodiment, the data passport 152 sits as an interface for the consumer. The comparison engine 154, the billing engine 156, and the services engine 158 utilize corresponding information from the data passport 152 to interface with the providers. In some embodiments, the data passport 152 receives user identification information from a user consumer, but uses separate identification information for interfacing with the providers via the API 202. In this way, the consumer's actual information may be kept confidential from the providers, allowing the API 202 and the transaction consolidation system 106 to filter out any unwanted or unapproved communications from reaching the consumer from the interactions with the providers.

Potential providers include carriers 204, payment processors 206, and other service providers 208. Other embodiments of the API 202 may interface with other types of providers. As mentioned above, the embodiments of the transaction consolidation system 106 are not limited to specific types of carriers, vendors, or other providers of goods and/or services.

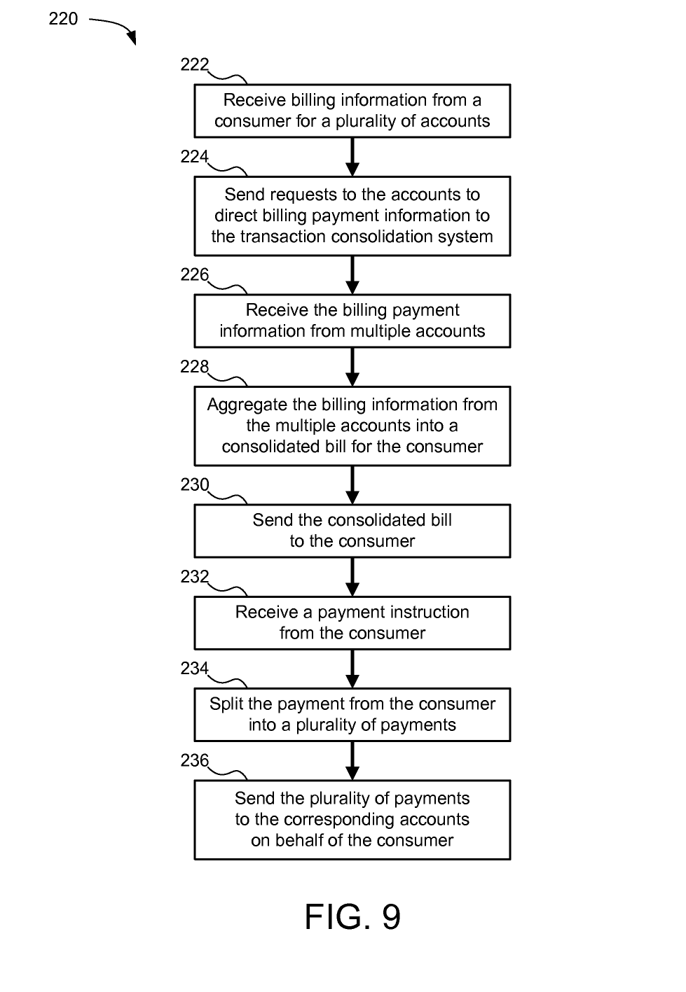

FIG. 9 depicts a flow chart diagram of one embodiment of a payment consolidation method 220 for implementation with the payment consolidator 142 of FIG. 2. Although the method 220 is described in conjunction with the payment consolidator 142 of FIG. 2 and the transaction consolidation system 106 of FIG. 1, embodiments of the method 220 may be implemented with other types of transaction consolidation systems and/or payment consolidators.

The depicted method 220 begins as the payment consolidator 142 receives 222 billing information from a user for a plurality of accounts with corresponding providers. The payment consolidator 142 sends 224 requests to the accounts to direct billing payment information to the transaction consolidation system 106. Such requests may be sent at the time that an account is established or at any point when the account is active for the consumer.

The payment consolidator 142 subsequently receives 226 the billing payment information from multiple accounts and aggregates 228 the billing information into a consolidated bill for the consumer. The payment consolidator 142 then sends 230 the consolidated bill to the consumer.

When the payment consolidator 142 receives 232 a payment from the consumer, or when the consumer instructs the payment consolidator 142 to trigger a payment, the payment consolidator 142 splits 234 the payment from the consumer into a plurality of payments corresponding to two or more of the accounts for which payments are due or outstanding. The payment consolidator 142 then sends 236 the payments, or initiates the payments on behalf of the user, to the corresponding accounts. The depicted method 220 then ends.

While there may be many benefits to embodiments of the payment consolidation functionality implemented by the payment consolidator 142, at least some embodiments provide consumer-based data collection, bill consolidation, price comparison, and payment aggregation. Other embodiments of the payment consolidator 142 may result in additional benefits.

FIG. 10 depicts a schematic block diagram of one embodiment of the quote consolidator 144 of FIG. 2. In general, the quote consolidator 144 aggregates quotes or other exploratory information from multiple providers of goods and/or services for convenient and efficient presentation to a consumer. This gives the consumer a single interface to receive and process quotes from multiple providers. The illustrated quote consolidator 144 includes a generation/assignment engine 252, a summary engine 254, a filter engine 256, and a forms engine 258. Other embodiments of the quote consolidator 144 may have fewer or more components.

In some embodiments, the quote consolidator 144 and its various components are implemented as software functions or modules stored on a tangible memory or storage device. In this implementation, the illustrated diagrams may be representative of computer program products in which executable software code is stored on a physical storage medium that can store signals representative of the executable software code in a non-volatile and non-transitory state, physically interface with the processor 120, and provide the stored executable software code to the processor 120 in response to instructions from the processor 120.

In some embodiments, the generation/assignment engine 252 manages some or all of a consumer's account information. The consumer may provide identifying information and send the information to the transaction consolidation system 106 through the internet 108 using an internet connection. The data processor 120 may be configured to receive the identifying information and use the generation/assignment engine 252 to generate and/or assign a second set of information corresponding to the received identifying information. The second set of information may include, for example, one or more elements, such as an alias email address to correspond with the consumer's actual email address (e.g. johndoe@address.com may become 16557@compare.com). It will be appreciated that the generation/assignment engine 252 may generate the element or, in the alternative, assign a predetermined element to the identifying information received from a consumer. By using separate information that is different from the consumer's actual information, the transaction consolidation system 106 may provide a level of insulation to the consumer from the third party providers and other unintended sources 110 who otherwise might obtain the consumer's contact information for marketing or other purposes. In further embodiments, the generation/assignment engine 252 may utilize multiple generated or assigned contact addresses (or other identifying contact information) for separate providers, or groups of providers.

The transaction consolidation system 106 then may send information using the corresponding element to one or more targeted third party service and/or product provider(s). This information may be sent as part of a request for a quote to purchase services and/or goods from the provider(s). The provider(s) may use the information to provide a response, such as a quote for services, which is sent back to the transaction consolidation system 106.

In some embodiments, a consumer may utilize a single set of sign-on information to access his or her account information at the quote consolidator 144. The single sign-on feature may allow the consumer to log in once in order to access the system and one or more sites of the providers without being prompted to log in again.

In some embodiments, the summary engine 254 provides a summary of a plurality of responses received from the providers. This summary may be generated each time a response is received or, alternatively, may be periodically provided to the consumer. For example, a plurality of responses may be provided to the consumer in a daily summary, a weekly summary, or a summary based on some other time variable basis. Additionally, the periodic delivery of such responses may be provided to the consumer in a format in which only the most desirable responses of the plurality of responses are provided.

In some embodiments, the transaction consolidation system 106 provides a consumer limited access to the memory device 126 and/or the storage device 128 to access specific responses that are summarized in the periodic summary sent to the consumer. In this way, the consumer may view and/or hear all responses received by the quote consolidator 144. In some embodiments, the consumer may have access to both the responses from targeted third party service and/or product provider(s) and other unsolicited or unwanted communications from the unintended sources 110.

In some embodiments, the filter engine 256 filters out response or communications from the unintended sources 110. It is not uncommon for sources, such as unintended sources 110, to also obtain the contact information of consumers by, for example, data mining, purchase, etc. These unintended sources 110 typically send unsolicited communications or other unwanted information to consumers who have shopped online and provided identifying information to providers. However, the use of secondary contact information by the transaction consolidation system 106 may limit the ability of these unintended sources 110 from getting the primary contact information of the consumer. In this way, the unintended sources 110 may only have the opportunity to obtain the secondary contact information, rather than the consumer's actual identifying information. So the filter engine 256 may easily direct unsolicited communications from the unintended sources 110 to the trash or to a quarantine location within the transaction consolidation system 106.

Responses received by the quote consolidator 144 from providers may be stored, for example, in an electronic folder (e.g., an email inbox and/or voicemail inbox). The quote consolidator 144 also may receive and store communications sent from the unintended sources 110. The filter engine 256 is able to segregate the quotes and information from the providers from other communications from the unintended sources 110. The responses from the providers then may be provided to the consumer in such a manner that unsolicited communications are omitted or easily distinguishable.

In some embodiments, the forms engine 258 generates and/or manages forms that may be used to obtain information from the consumer. For example, the form engine 258 may provide a form having requests for receiving identifying information from a consumer. Thus, a consumer may be able to enter identifying information on the form.

FIG. 11 depicts a schematic block diagram of another embodiment of a quote consolidator 260. The illustrated quote consolidator 260 includes a receiver 262 for receiving identifying information from a consumer and responses from providers. Alternatively, quote consolidator 260 may include a plurality of receivers 262, with each receiver 262 dedicated to a particular source of information. For example, one receiver 262 may receive the identifying information from a consumer, and another receiver 262 may receive responses from specific provider.

Similarly, the illustrated quote consolidator 260 includes a sender 264 or a plurality of senders 264. Each sender 264 is configured to send information to the consumer and/or one or more providers.

The illustrated quote consolidator 260 also includes a generation/assignment engine 252, with functionality as described above with reference to FIG. 10. The illustrated quote consolidator 260 also includes a storage engine 266 to manage quote data stored on the transaction consolidation system 106. The storage engine 266 may be used by the receiver 262 and the sender 264 when communicating with a consumer and/or providers.

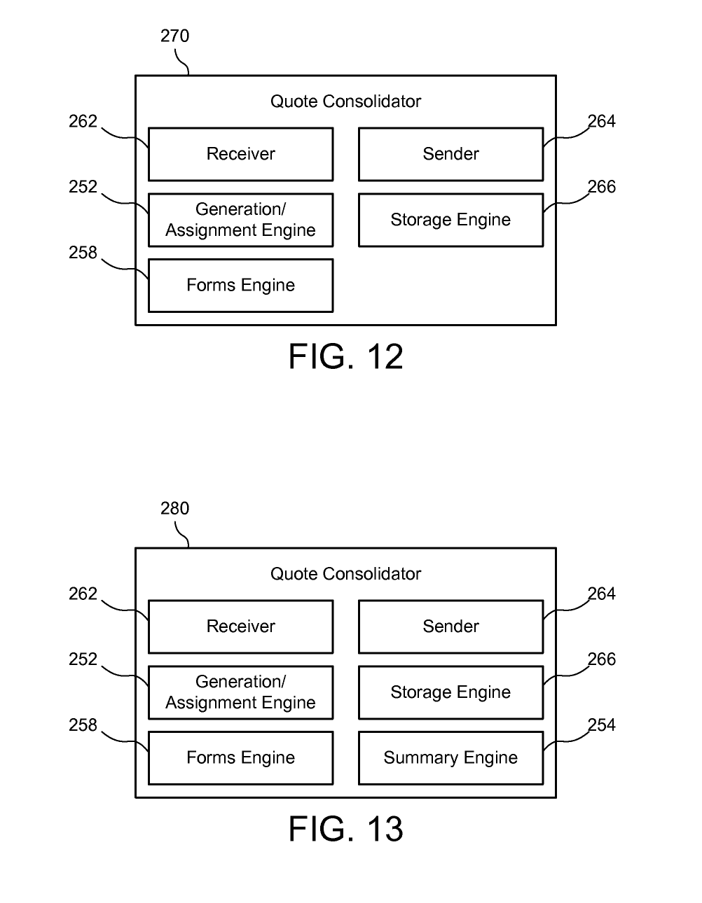

FIG. 12 depicts a schematic block diagram of another embodiment of a quote consolidator 270. The illustrated quote consolidator 270 includes many or all of the components of the quote consolidator 260 shown in FIG. 11 and described above. The illustrated quote consolidator 270 also includes a forms engine 258 with the same or similar functionality as described above with reference to FIG. 10.

FIG. 13 depicts a schematic block diagram of another embodiment of a quote consolidator 280. The illustrated quote consolidator 280 includes many or all of the components of the quote consolidator 270 shown in FIG. 12 and described above. The illustrated quote consolidator 280 also includes a summary engine 254 with the same or similar functionality as described above with reference to FIG. 10.

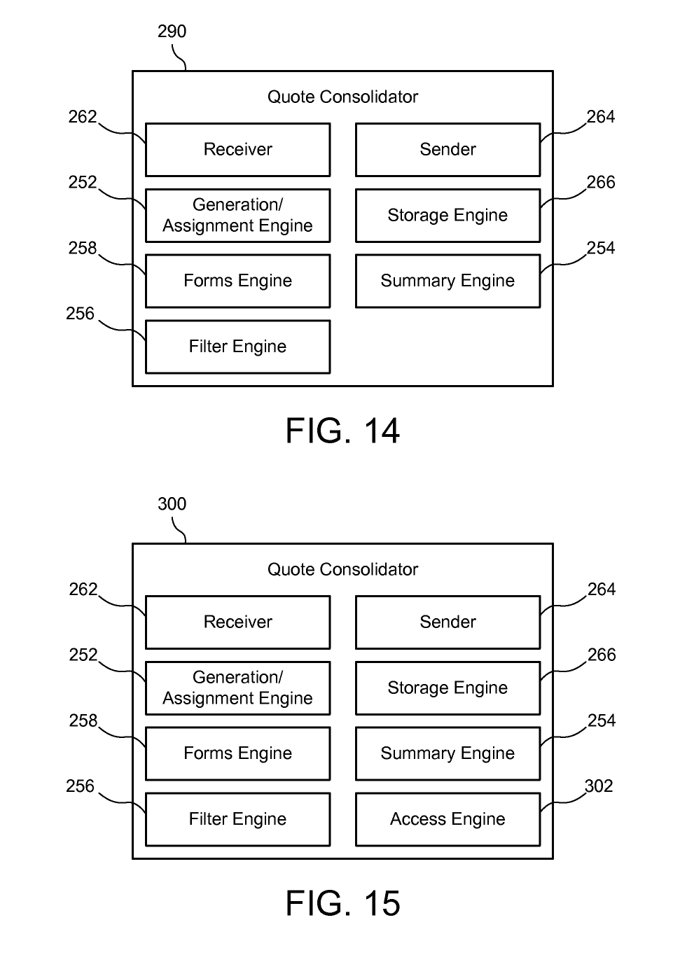

FIG. 14 depicts a schematic block diagram of another embodiment of a quote consolidator 290. The illustrated quote consolidator 290 includes many or all of the components of the quote consolidator 280 shown in FIG. 13 and described above. The illustrated quote consolidator 290 also includes a filter engine 256 with the same or similar functionality as described above with reference to FIG. 10.

FIG. 15 depicts a schematic block diagram of another embodiment of a quote consolidator 300. The illustrated quote consolidator 300 includes many or all of the components of the quote consolidator 290 shown in FIG. 14 and described above. The illustrated quote consolidator 300 also includes an access engine 302. In some embodiments, the access engine 302 provides limited access to a consumer such that the consumer is able to obtain, view, hear, etc. all responses (e.g., responses received from both targeted third party service and/or product providers and also unintended sources 110) while those responses are stored in the memory device 126 and/or the storage device 128.

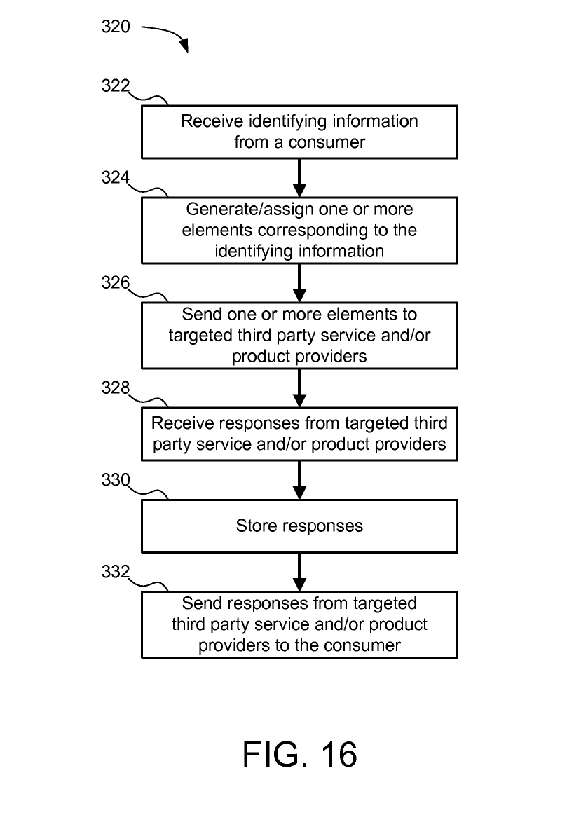

FIG. 16 depicts a flow chart diagram of one embodiment of a quote consolidation method 320 for implementation with the quote consolidator 144 of FIG. 2. Although the method 320 is described in conjunction with the quote consolidator 144 of FIG. 2 and the transaction consolidation system 106 of FIG. 1, embodiments of the method 320 also may be implemented with other types of transaction consolidation systems and/or quote consolidators.

The depicted method 320 begins as the quote consolidator 144 receives 322 identifying information from a consumer. Once the identifying information is received, the quote consolidator 144 generates and/or assigns 324 new identifying information to the consumer. As explained above, this new identification information may include an alias email address or other alias contact information to send to the providers, instead of sending the consumer's actual contact information. The quote consolidator 144 subsequently sends 326 one or more of the elements of the assigned contact information to a targeted third party service and/or products provider. The one or more elements may include information that may be used by the targeted third party service and/or products provider to prepare a response, such as a quote for services (e.g., car insurance quote, health insurance quote, mobile telephone and/or data quote, etc.).

The quote consolidator 144 then receives 328 and stores 330 responses from the targeted third party service and/or product providers. For example, a targeted third party service and/or products provider may call the predetermined phone number to leave an audible message, which is received and stored. The message may be stored in a voicemail folder that can be accessed by the consumer to listen to the audible message and/or, alternatively, the audible message may be converted into a text format and stored in an email inbox, which may be viewable by the consumer.

The quote consolidator 144 then sends 332 the responses from the targeted third party service and/or product providers to the consumer. Alternatively, the quote consolidator 144 sends a notification to the consumer that the responses are available at the transaction consolidation system 106. The depicted method 320 then ends.

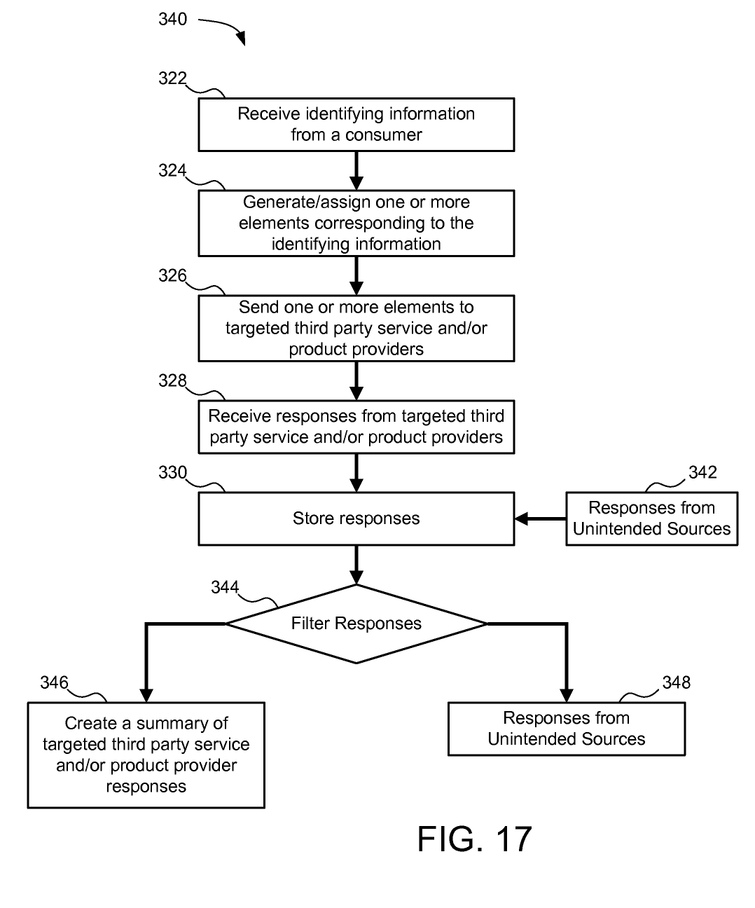

FIG. 17 depicts a flow chart diagram of another embodiment of a quote consolidation method 340 for implementation with the quote consolidator 144 of FIG. 2. Although the method 340 is described in conjunction with the quote consolidator 144 of FIG. 2 and the transaction consolidation system 106 of FIG. 1, embodiments of the method 340 also may be implemented with other types of transaction consolidation systems and/or quote consolidators.

The illustrated method 340 includes the same or similar operations 322-330 as shown in FIG. 16 and described above. Additionally, the method 340 includes receiving 342 and storing 330 responses from one or more unintended sources 110. The quote consolidator 144 then filters 344 the responses received from targeted third party service and/or products providers from those received from unintended sources 110. The quote consolidator 144 then creates 346 a summary of the provider responses. The quote consolidator 144 also may retain 348 copies of the communications from the unintended sources 110. Alternatively, the quote consolidator 144 may simply delete such unauthorized communications. The depicted method 340 then ends.

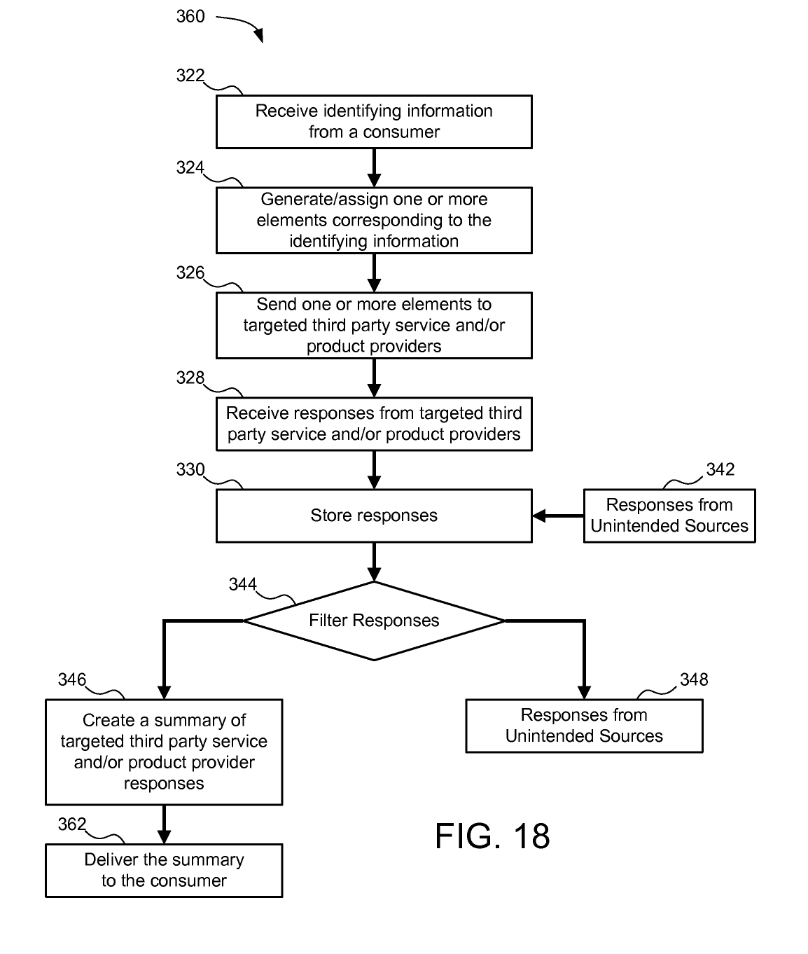

FIG. 18 depicts a flow chart diagram of another embodiment of a quote consolidation method 360 for implementation with the quote consolidator 144 of FIG. 2. Although the method 360 is described in conjunction with the quote consolidator 144 of FIG. 2 and the transaction consolidation system 106 of FIG. 1, embodiments of the method 360 also may be implemented with other types of transaction consolidation systems and/or quote consolidators.

The illustrated method 360 includes the same or similar operations 322-348 as shown in FIG. 17 and described above. Additionally, the method 360 includes sending 362 the summary of the provider responses, or a corresponding notification of those responses, to the consumer. In some embodiments, the summary may include only a subset of the response received from the providers. A summary of the subset of responses may be periodically provided to the consumer, for example, on a daily, weekly, or some other time variable basis. According to one embodiment, the subset of responses may be selected and sent to the consumer as being potentially the most desirable responses from the providers. Filtering criteria may be used to determine which responses are most desirable. Such criteria may include, for example, cost considerations, availability, delay, warranties, locality, and so forth.

While there may be many benefits to embodiments of the quote consolidation functionality implemented by the quote consolidator 144, at least some embodiments provide third party service and/or product comparisons. Other embodiments of the quote consolidator 144 may result in additional benefits.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system to consolidate user interactions with providers, the system comprising:
an electronic data storage device to store user information corresponding to a user;
a data processor coupled to the electronic data storage device, the data processor to administer electronic communications with a plurality of the providers of goods and/or services; and
a consolidation manager to aggregate information from the plurality of the providers into a consolidated format for presentation to the user.

2. The system of claim 1, wherein the consolidation manager further comprises a payment consolidator to consolidate payment information for a plurality of existing accounts with the plurality of the providers.

3. The system of claim 2, wherein the payment consolidator further comprises a billing engine to periodically generate a consolidated bill from a plurality of individual bills for the plurality of the existing accounts and to send the consolidated bill to the user in place of the plurality of bills for the plurality of the existing accounts.

4. The system of claim 2, wherein the payment consolidator further comprises a data passport to store and maintain identifying information for the user.

5. The system of claim 4, wherein the data passport is further configured to store and maintain account information for the plurality of the existing accounts.

6. The system of claim 5, wherein the payment consolidator is further configured to act as an intermediary between the user and the plurality of the providers and to maintain the user information confidential from the plurality of the providers.

7. The system of claim 2, wherein the payment consolidator further comprises a services engine to receive updates on contractual terms of the plurality of the existing accounts with the plurality of the providers.

8. The system of claim 2, wherein the payment consolidator further comprises a comparison engine to compare contractual terms of at least one of the providers with different contractual terms of a potential provider for corresponding goods and/or services.

9. The system of claim 1, wherein the consolidation manager further comprises a quote consolidator to consolidate quote information for a potential purchase from the plurality of the providers.

10. The system of claim 9, wherein the quote consolidator further comprises:
a sender to send requests to the plurality of the providers for price quotes associated with the goods and/or the services; and
a receiver to receive the price quotes from the plurality of the providers.

11. The system of claim 10, wherein the quote consolidator further comprises a summary engine to create a summary of a plurality of the price quotes, and the sender is further configured to send the summary to the user.

12. The system of claim 9, wherein the quote consolidator further comprises a generation/assignment engine to correlate account information of the user with secondary contact information assigned to the user, wherein the quote consolidator is further configured to maintain the account information of the user confidential from the plurality of the providers.

13. The system of claim 9, wherein the quote consolidator further comprises a filter engine to pass communications from the providers to the user and to filter out communications from unintended sources.

14. A method for consolidating payment information, the method comprising:
receiving billing information of a user for a plurality of existing accounts with a corresponding plurality of providers of goods and/or services;
aggregating the billing information from the plurality of the existing accounts;
generating a consolidated bill for the user based on the aggregated billing information; and
delivering the consolidated bill to the user.

15. The method of claim 14, further comprising:
receiving a payment instruction from the user, wherein the payment instruction specifies a payment amount;
splitting the payment amount into a plurality of payments amounts; and
distributing the plurality of the payments amounts to a corresponding number of the plurality of the existing accounts.

16. A method for anonymous comparison shopping, the method comprising:
receiving identifying information from a user;
assigning new identifying information to the user;
sending at least a portion of the new identifying information to a vendor to request a quote; and
delivering the quote from the vendor to the user.

17. The method of claim 16, further comprising recording a correlation between the new identifying information and the information from the user.

18. The method of claim 16, further comprising:
sending at least portions of the new identifying information to a plurality of vendors to request quotes for potentially comparable products or services; and
delivering a summary of the quotes from the plurality of the vendors to the user.

19. The method of claim 18, further comprising:
identifying contrasting characteristics between at least two of the quotes from the plurality of the vendors; and
emphasizing the contrasting characteristics in the quotes delivered to the user.

20. The method of claim 16, further comprising:
receiving unsolicited information from at least one unintended source using the new identifying information;
confirming the unsolicited source is not the vendor; and
filtering the unsolicited information from the quote from the vendor to omit the unsolicited information from communications delivered to the user.
